(19) United States
(12) Patent Application Publication
(10) Pub. No.: US 2014/0097186 A1
(43) Pub. Date: Apr. 10, 2014

(54) CRATE

(71) Applicants: Michael D. Stolzman, Lake Forest, IL (US); Kenneth J. Kuzelka, Island Lake, IL (US)

(72) Inventors: Michael D. Stolzman, Lake Forest, IL (US); Kenneth J. Kuzelka, Island Lake, IL (US)

(21) Appl. No.: 13/647,068

(22) Filed: Oct. 8, 2012

(51) Int. Cl. B65D 6/08; B29C 70/00

(52) U.S. Cl. 220/494; 264/241

(57) ABSTRACT

A container is provided. The container is configured to receive other containers containing materials to be held and/or transported.

### BACKGROUND OF THE INVENTION

The present invention relates generally to the field of containers. The present invention relates more specifically to a plastic crate for holding bottles.

### SUMMARY OF THE INVENTION

One embodiment of a plastic crate includes first, second, third, and fourth plastic walls, each including an open-lattice portion. The first wall extends from the second wall generally perpendicularly. The third wall extends from the second wall distal from the first wall. The fourth wall extends between the first wall and the third wall distal from the second wall. The first and fourth walls include a corner portion. The crate includes a plastic base portion. The base portion extends between the first, second, third, and fourth walls. The first, second, third, and fourth walls and the base portion form an open-topped enclosure having an interior cavity. The base portion includes a central portion with a bottom surface extending in a first plan and corner portion with a bottom surface extending from the central portion in a second plane. The second pane forms a non-zero angle with the first plane. The corner portion includes a post portion and a projecting wall extending outwardly from the post portion. The projecting wall defines a first channel and a second channel spaced apart from the first channel.

An embodiment of a plastic molded crate includes four plastic sidewalls and a plastic base portion forming an open-topped enclosure. The plastic molded crate includes four corner projecting walls each projecting angularly outwardly from a junction of two of the four sidewalls. Each projecting wall includes an outer surface defining an upper channel and a lower channel. The base portion includes a central portion having a lower surface located in a first portion and four corner portions. Each corner portion has a lower surface located in a different plane forming a non-zero angle with the first plane.

An embodiment of a method of providing a plastic crate includes two-part molding a plastic crate having four walls, four corners, and a base portion. A bottom portion of each of the four corners is tapered inwardly. The base portion has a central portion with a lower surface located in a horizontal plane. Each of the four walls defines an aperture. The four walls and the base portion form an open-topped cavity with a volume of at least 16 quarts. The method includes shipping the plastic crate to a second location for filling.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of an embodiment of a crate.

FIG. 2 is a side view of an embodiment of a crate.

FIG. 3 is a front view of an embodiment of a crate.

FIG. 4 is detail view of the area 4 in FIG. 2.

FIG. 5 is a detail view of a fourth side and a portion of a corner portion of the crate of FIG. 1.

FIG. 6 is a detail view of the area 6 shown in FIG. 2.

FIG. 7 is a bottom perspective view of an embodiment of a crate.

FIG. 8 is a top plan view of an embodiment of a crate.

FIG. 9 is a bottom plan view of an embodiment of a crate.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Generally, in one embodiment, an open-topped, plastic container is provided. The container is configured to hold other containers for transporting the other containers, e.g., containers for liquids such as milk, juice, etc., containers for solid products such as sour cream, dips, etc., containers for other edible or non-edible products, etc. Embodiments of open-topped, plastic containers may be handled and processed by various automated apparatuses, e.g., machinery in an automated line, etc. Additionally, in some embodiments, loaded open-topped, plastic containers may be transported by human operators using, e.g., dollies, hand-carts, other suitable apparatuses, etc., in combination with restraints such as, e.g., straps, ropes, chains, woven restraints, plastic restraints, other suitable restraints configured to maintain the position of one or multiple crates relative to the carrying device, such as the dolly, etc.

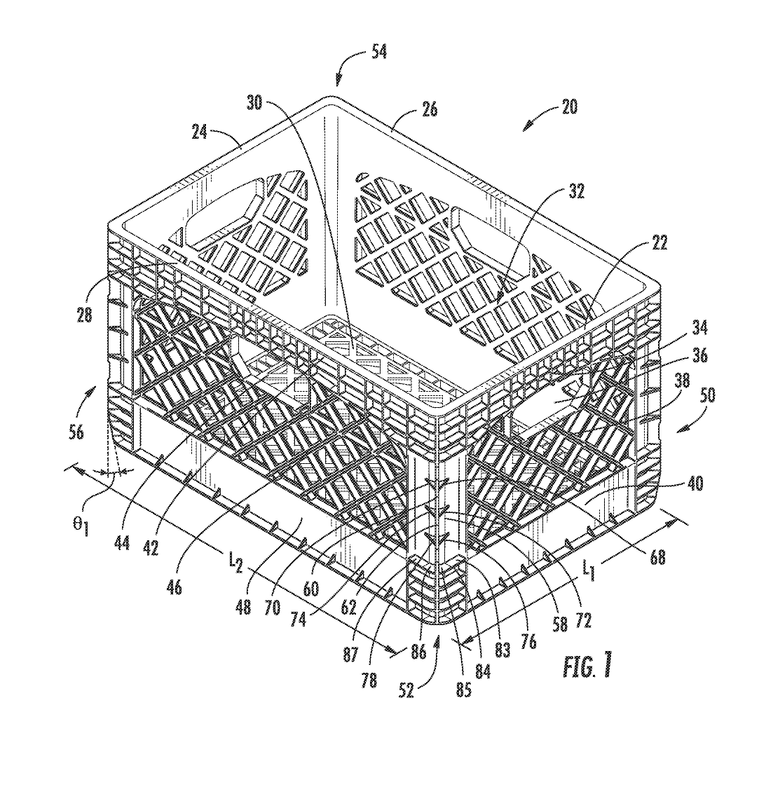

Referring to FIG. 1, an embodiment of a container, shown as a crate 20 in FIG. 1, is illustrated. In one embodiment, the crate 20 includes a first wall 22 and a second wall 24 spaced apart from and extending generally parallel to the first wall 22. The crate 20 also includes a third wall 26 and a fourth wall 28 spaced apart from the third wall 26, the third 26 and fourth 28 walls extending generally parallel to one another between the first 22 and second 24 walls generally perpendicular to the first 22 and second 24 walls. The first and second walls 22 and 24 each have a first length L₁. The third and fourth walls 26 and 28 each have a second length L₂. In one embodiment, the second length L₂ is greater than the first length L₁. In another embodiment, the first length L₁ of the first and second walls 22 and 24 is approximately equal to the second length L₂ of the third and fourth walls 26 and 28.

In one embodiment, the first length L₁ is between approximately 5 inches and approximately 20 inches. In another embodiment, the first length L₁ is between approximately 10 inches and approximately 15 inches. In another embodiment, the first length L₁ is approximately 12 inches.

In one embodiment, the second length L₂ is between approximately 10 inches and approximately 25 inches. In another embodiment, the second length L₂ is between approximately 15 inches and approximately 20 inches. In another embodiment, the second length L₂ is approximately 18 inches.

In one embodiment, the crate 20 has a height of between 5 inches and approximately 25 inches. In another embodiment, the crate 20 has a height of between approximately 8 inches and approximately 15 inches. In another embodiment, the crate 20 has a height of approximately 11 inches.

In one embodiment, the crate 20 also includes a base portion 30. The base portion 30 extends generally perpendicularly to the first, second, third, and fourth walls 22, 24, 26, and 28. The base portion 30 and the walls 22, 24, 26, and 28 form a generally rectangular, open-topped interior cavity 32 of the crate 20.

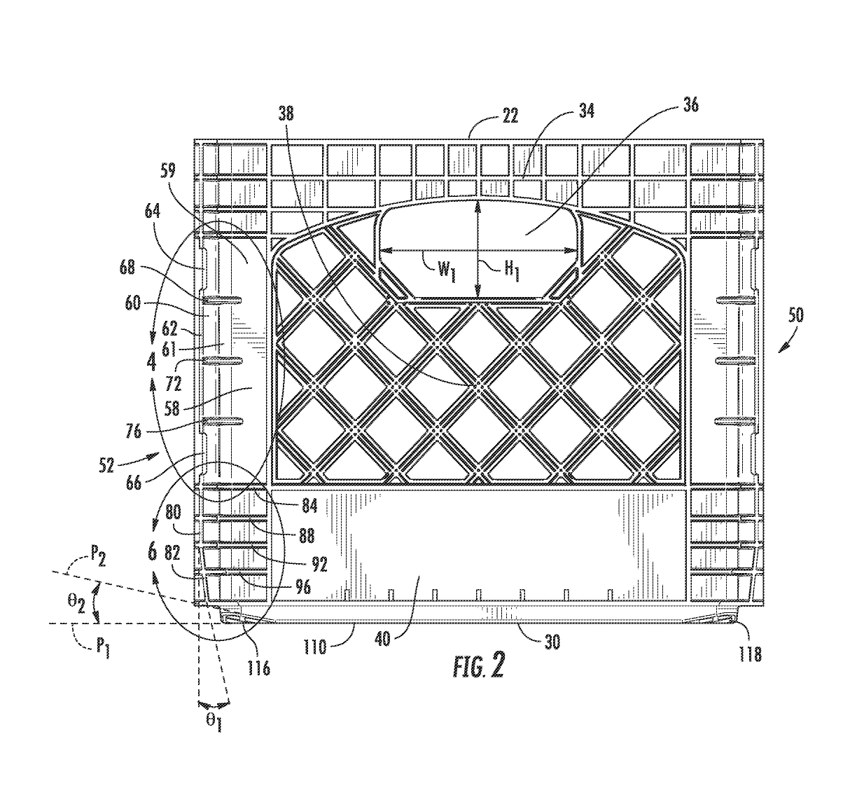

With reference to FIGS. 1 and 2, in one embodiment, the first wall 22 includes a solid top portion 34. In one embodiment, the solid top portion 34 does not include apertures extending through the first wall 22. In one embodiment, the exterior surface of the solid top portion 34 may be patterned, e.g., regularly or irregularly shaped and spaced ribbing and pockets, etc., while the interior surface of the solid top portion 34 may be generally flat.

In one embodiment, below the solid top portion 34, the first wall 22 defines a handle 36. In one embodiment, the handle 36 is configured such that a user's hand may be received therein to grasp the solid top portion 34. The first wall 22 also includes an open lattice or fence-patterned portion 38 including a plurality of apertures extending through the first wall 22. In one embodiment, the apertures in the open lattice portion 28 are generally diamond-shaped. The fence-patterned portion 38 is located below the top solid portion 34. Below the fence-patterned portion 38, the first wall 22 includes a bottom solid portion 40. In one embodiment, the bottom solid portion 40 does not include apertures extending through the first wall 22 and includes a generally flat portion.

In the illustrated embodiment, the second wall 24 is generally similar to and has generally similar features as the first wall 22.

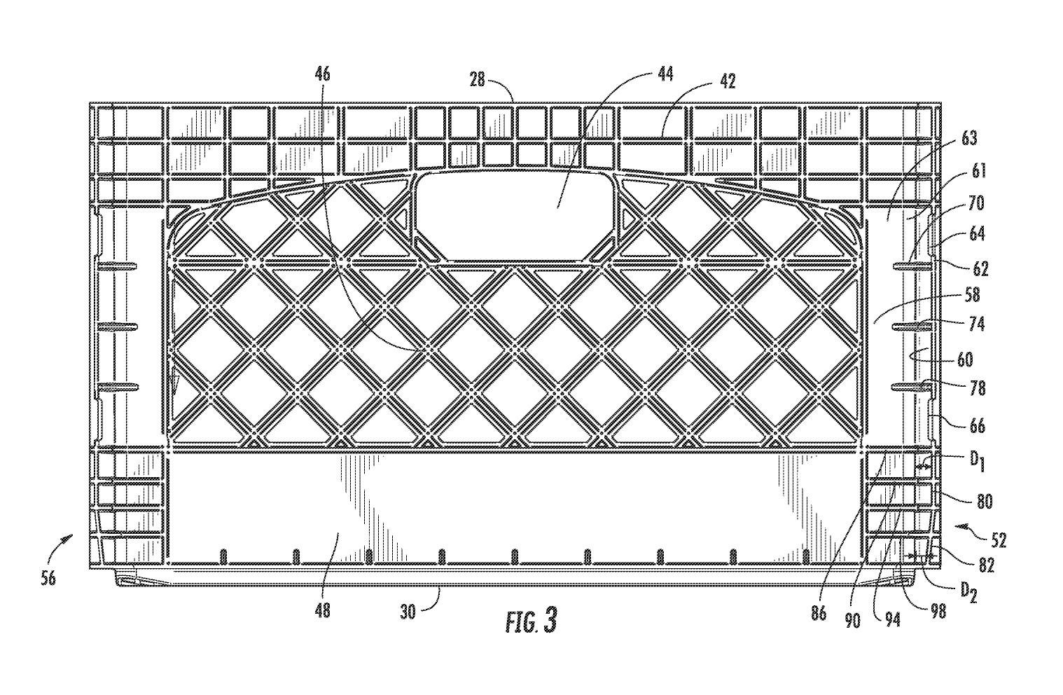

With further reference to FIGS. 1 and 3, the fourth wall 28 includes a solid top portion 42. The solid top portion 42 does not include apertures extending through the fourth wall 28. In one embodiment, the exterior surface of the solid top portion 42 may be patterned, e.g., regularly or irregularly shaped and spaced ribbing and pockets, etc., while the interior surface of the solid top portion 42 may be generally flat.

In one embodiment, below the solid top portion 42, the fourth wall 28 defines an aperture 44. In one embodiment, the aperture 44 is configured such that a user's hand may be received therein to grasp the solid top portion 42. The fourth wall 28 also includes an open lattice or fence-pattern portion 46 including a plurality of apertures extending through the fourth wall 28. In one embodiment, the apertures in the open lattice portion are generally diamond-shaped. The fence-patterned portion 46 is located below the top solid portion 42. Below the fence-patterned portion 46, the fourth wall 28 includes a bottom solid portion 48. In one embodiment, the bottom solid portion 48 does not include apertures extending through the fourth wall 28 and includes a generally flat portion.

In the illustrated embodiment, the third wall 26 is generally similar and has generally similar features to the fourth wall 28.

With reference to FIG. 1, the first wall 22 and the third wall 26 include a first corner portion 50 proximate where the first and third walls 22 and 26 are coupled. Similarly, the first wall 22 and the fourth wall 28 include a second corner portion 52 proximate where the first and fourth walls 28 are coupled. Additionally, the second wall 24 and the third wall 26 include a third corner portion 54 proximate whether the second and third walls 24 and 26 are coupled. And, the second wall 24 and the fourth wall 28 include a fourth corner portion 56 proximate where the second and fourth walls 24 and 28 are coupled. In one embodiment, the corner portions 50, 52, 54, and 56 are generally similar. The corner portion 52 is described in detail, with embodiments of corner portions 50, 54, and 56 having generally similar characteristics and features and being generally similar.

With reference to FIGS. 1-3, in one embodiment, the corner portion 52 includes a post portion 58 extending between the fence-patterned portion 38 and solid bottom portion 40 of the first wall 22 and the fence-patterned portion 46 and solid bottom portion 48 of the fourth wall 28. The post portion 58 extends between the solid top portions 34 and 42 and the base 30. In one embodiment, the post portion 58 includes a first portion 59 extending from the fence-patterned portion 46 and solid bottom portion 40 generally parallel therewith, a rounded portion 61 extending from the first portion 59, and a second portion 63 extending from the rounded portion 61 to the fence-patterned portion 46 and solid bottom portion 48 generally parallel with the fence-patterned portion 46 and solid bottom portion 48.

In one embodiment, extending angularly outwardly from the post portion 58 is a wall 60. The wall 60 extends downwardly from the top portions 34 and 42 to the base 30. In one embodiment, the wall 60 forms an approximately 135° angle with each of the first wall 22 and the fourth wall 28.

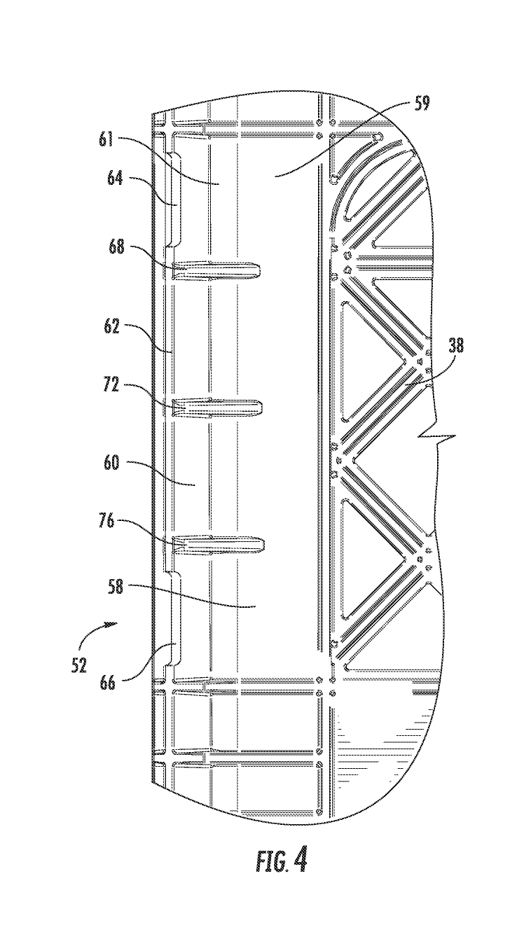

With reference to FIGS. 1-4, in one embodiment, the wall 60 has an outer surface 62 distal from the post portion 58. Defined in the outer surface 62 are an upper retaining channel 64 and a lower retaining channel 66 spaced apart from the upper channel 64. In one embodiment, the upper retaining channel 64 is located above the midpoint of the height of the crate 20. In one embodiment, the lower retaining channel 66 is located below the midpoint of the height of the crate 20.

In one embodiment, the retaining channels 64 and 66 are configured to receive and removably retain restraints therein, deterring the restraints from upward or downward displacement relative to the crate 20.

With further reference to FIGS. 1-4, in one embodiment, the second corner portion 52 also includes an upper pair of ribs 68 and 70 extending from the post portion 58 to opposite sides of the wall 60 respectively generally perpendicular to the wall 60. In one embodiment, the ribs 68 and 70 are generally vertically aligned with one another. In one embodiment, the ribs 68 and 70 may provide support for the wall 60. In one embodiment, the ribs 68 and 70 may deter deflection of the wall 60.

In one embodiment, the second corner portion 52 also includes a middle pair of ribs 72 and 74 extending from the post portion 58 to opposite sides of the wall 60 respectively below and generally parallel with the upper pair of ribs 68 and 70 and generally perpendicular to the wall 60. In one embodiment, the ribs 72 and 74 are generally vertically aligned with one another. In one embodiment, the ribs 72 and 74, along with the upper pair of ribs 68 and 70, may provide support for the wall 60. In one embodiment, the ribs 72 and 74, along with the upper pair of ribs 68 and 70, may deter deflection of the wall 60.

In one embodiment, the second corner portion 52 also includes a lower pair of ribs 76 and 78 extending from the post portion 58 to opposite sides of the wall 60 respectively below and generally parallel with both the upper pair of ribs 68 and 70 and the middle pair of ribs 72 and 74 and generally perpendicular to the wall 60. In one embodiment, the ribs 76 and 78 are generally vertically aligned with one another. In one embodiment, the ribs 76 and 78, along with the upper pair of ribs 68 and 70 and the middle pair of ribs 72 and 74, may provide support for the wall 60. In one embodiment, the ribs 76 and 78, along with the upper pair of ribs 68 and 70 and the middle pair of ribs 72 and 74, may deter deflection of the wall 60. In the illustrated embodiment, the ribs 68, 70, 72, 74, 76, and 78 terminate short of the fence-patterned portions 38 and 46.

While the corner portion 52 is illustrated having three pairs of ribs, in other embodiments, corner portions may include any other suitable number of ribs. In one embodiment, the corner portion 52 includes more than two pairs of ribs.

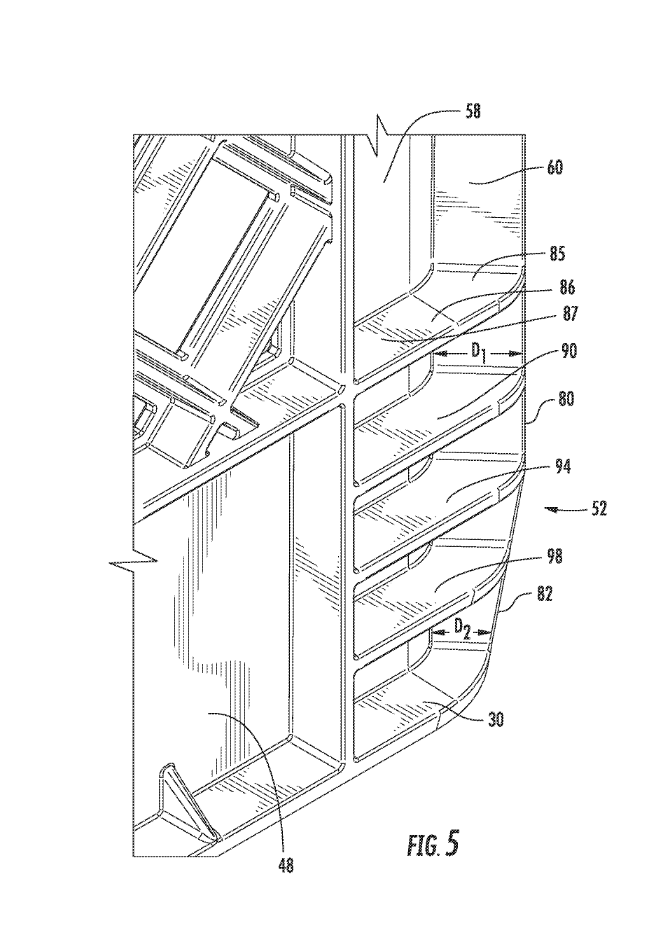

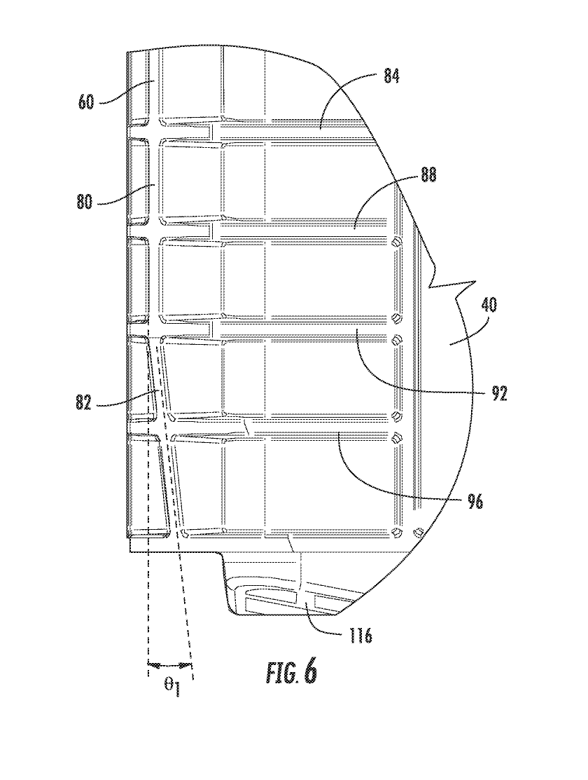

With reference to FIGS. 2, 3, 5, and 6, in one embodiment, the wall 60 includes a first portion 80 of the outer surface 62 of the wall 60, below the lower channel 66, extending generally vertically, generally parallel with the first 22 and fourth 28 walls. The wall 60 also includes a second portion 82 of the outer surface 62 of the wall 60 extending from the first portion 80 downwardly to the base 30. The second portion 82 extends non-vertically and is angled inwardly, extending non-parallel with the first portion 80. As is illustrated in FIGS. 2 and 6, the second portion 82 forms an angle θ₁ with the first portion 80. In one embodiment, the angle θ₁ is greater than approximately 5°. In another embodiment, the angle θ₁ is greater than approximately 10°. In another embodiment, the angle θ₁ is greater than approximately 15°. In another embodiment, the angle θ₁ is greater than approximately 20°. In another embodiment, the angle θ₁ is greater than approximately 30°. In one embodiment, the second portion 82 extending non-parallel and angularly with the first portion 80 may provide for handling an embodiment of the crate by machinery without interference between the bottom portion of the wall 60 (e.g., proximate the second portion 82) and the machinery. In another embodiment, the second portion 82 extending non-parallel and angularly with the first portion 80 may avoid damage to embodiments of crates during handling by machinery.

With reference to FIGS. 2, 3, 5, and 6, in one embodiment, the corner portion 52 includes a lower set of pairs of ribs extending from the bottom solid portions 40 and 48 to the wall 60. In one embodiment, the corner portion 52 includes a first pair of lower ribs 84 and 86 extending between the bottom solid portion 40 of the first wall 22 to the wall 60 and between the bottom solid portion 48 of the fourth wall 28 to the wall 60 respectively. The ribs 84 and 86 are generally vertically aligned with one another and extend generally in a horizontal plane to the wall 60.

As illustrated in FIG. 1, in one embodiment, the ribs 84 and 86 include a first portion 83 generally matching and extending generally perpendicularly to the portion 59 of the post portion 58, a second rounded portion 85 generally matching and extending generally perpendicular to the rounded portion 61 of the post portion 58, and a third portion 87 generally matching and extending generally perpendicular to the second portion 63 of the post portion 58.

In one embodiment, the corner portion 52 includes a second pair of lower ribs 88 and 90, located below the first lower pair of ribs 84 and 86, extending between the bottom solid portion 40 of the first wall 22 to the wall 60 and between the bottom solid portion 48 of the fourth wall 28 to the wall 60 respectively. The ribs 88 and 90 are generally vertically aligned with one another and extend generally parallel with the ribs 84 and 86.

In one embodiment, the corner portion 52 includes a third pair of lower ribs 92 and 94, located below the second pair of lower ribs 88 and 90, extending between the bottom solid portion 40 of the first wall 22 to the wall 60 and between the bottom solid portion 48 of the fourth wall 28 to the wall 60 respectively. The ribs 92 and 94 are generally vertically aligned with one another and extend generally parallel with the ribs 84, 86, 88, and 90.

In one embodiment, the corner portion 52 includes a fourth pair of lower ribs 96 and 98, located below the third pair of lower ribs 92 and 94, extending between the bottom solid portion 40 of the first wall 22 to the wall 60 and between the bottom solid portion 48 of the fourth wall 28 to the wall 60 respectively. The ribs 96 and 98 are generally vertically aligned with one another and extend generally parallel with the ribs 84, 86, 88, 90, 92, and 94. In one embodiment, the ribs 84, 86, 88, 90, 92, 94, 96, and 98 may provide support for the wall 60. In one embodiment, the ribs 84, 86, 88, 90, 92, 94, 96, and 98 may deter deflection of the wall 60.

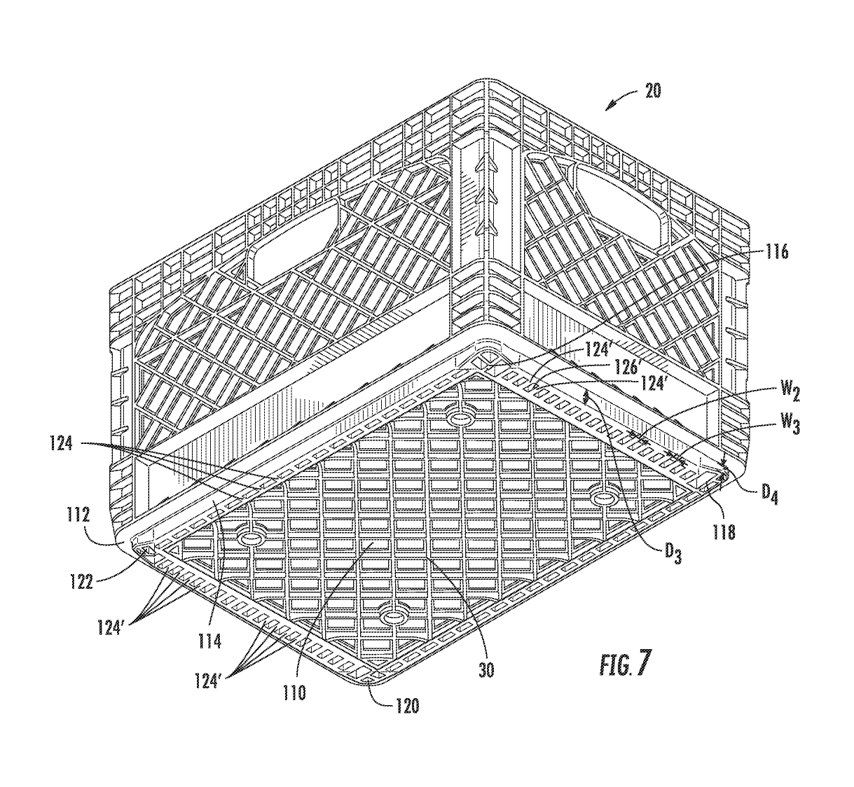

With reference to FIG. 7, in one embodiment, the base portion 30 includes a central, generally planar, generally rectangular, lower portion 110 and an outer raised portion 112 extending generally around the perimeter of the central lower portion 110, generally in a plane parallel to but not co-planar with the plane in which the central lower portion 110 is located.

In one embodiment, extending between the central lower portion 110 and the outer raised portion 112 is a generally vertical wall portion 114. The wall portion 114 extends between the central lower portion 110 and the outer raised portion 112 generally perpendicular to both the central lower portion 110 and the outer raised portion 112.

In one embodiment, the base portion 30 also includes corner portions 116, 118, 120, and 122 proximate each of the corners of the generally rectangular, central lower portion 110. The corner portions 116, 118, 120, and 122 extend generally angularly away from the central lower portion 110. With reference to FIG. 2, the bottom surface of the central lower portion 110 generally is located in a plane P₁. The bottom surface of the corner portion 116 generally is located in a plane P₂. An angle θ₂ is defined between the planes P₁ and P₂. In one embodiment, the angle θ₂ is greater than approximately 5°. In another embodiment, the angle θ₂ is greater than approximately 10°. In another embodiment, the angle θ₂ is greater than approximately 15°. In another embodiment, the angle θ₂ is greater than approximately 20°. In another embodiment, the angle θ₂ is greater than approximately 25°. In another embodiment, the angle θ₂ is greater than approximately 30°.

As is illustrated in, for example, FIGS. 2 and 7, in one embodiment, the angle formed between the lower surfaces of each of the corner portions 116, 118, 120, and 122 and the vertical wall portion 114 is greater than 90°.

In one embodiment, the corner portions 118, 120, and 122 similarly to corner portion 116, have lower surfaces that are located in planes that are non-coplanar with the plane P₁ in which the bottom surface of the central portion 110 is located. The planes in which the lower surfaces of the corner portions 118, 120, and 122 are located similarly form angles with the plane P₁ in which the lower surface of the central portion 110 is located.

In one embodiment, the corner portions 116, 118, 120, and 122 may provide for handling of the crate 20 by machinery without interference between the base portion 30 and the machinery. In another embodiment, the corner portions 116, 118, 120, and 122 may provide for handling of the crate 20 by machinery without damage to the crate.

With further reference to FIG. 7, in one embodiment, the wall portion 114 extends a distance D₃ in a direction perpendicular to the lower portion 110, along the sides of the generally rectangular, lower portion 110. The wall portion 114 extends a decreasing distance in the direction from the portion of the wall 114 proximate the lower portion 110 to the portion of the wall 114 along the corner portions 116, 118, 120, and 122, e.g., D₄, the vertical distance the wall 114 extends in portions proximate corner portions, such as, e.g., corner portion 118, is less than the distance D₃ in portions along the sides of the generally rectangular, lower portion 110.

Around the perimeter of the generally rectangular, lower portion 110, the base portion 30 includes a plurality of ribs 124 and 124′ (only selected ones of the ribs 124 and 124′ labeled in FIG. 7 for clarity, but, in one embodiment, the ribs being located around the whole lower portion 110, such as, e.g., the embodiment illustrated in FIG. 7). In one embodiment, along the sides of the lower portion 110 of the crate 20 proximate the first wall 22 and the third wall 26, the base portion 30 includes at least twelve ribs. In another embodiment, illustrated in FIG. 7, along the sides of the crate 20 proximate the first wall 22 and the third wall 26, the base portion 30 includes nineteen ribs 124′. In one embodiment, the ribs 124′ may provide support for the base portion 30 and the crate 20 generally.

In one embodiment, along the sides of the lower portion 110 proximate the first wall 22 and the third wall 26, apertures 126′ are defined between the ribs 124′. In one embodiment, the ribs 124′ have a width W₂. In one embodiment, the width W₂ is between approximately 0.1 inches and approximately 0.3 inches. In another embodiment, the width W₂ is between approximately 0.2 inches and approximately 0.3 inches. In another embodiment, the width W₂ is approximately 0.11 inches. In another embodiment, the width W₂ is greater than approximately 0.2 inches. In another embodiment, the width W₂ is greater than approximately 0.25 inches. In another embodiment, the width W₂ is approximately 0.27 inches. In one embodiment, the apertures 126′ along the sides of the lower portion 110 proximate the first wall 22 and the third wall 26 have a width W₃. In one embodiment, the width W₃ is between approximately 0.2 inches and approximately 0.3 inches. In one embodiment, the width W₃ is approximately 0.26 inches. In another embodiment, the width W₃ is less than approximately 0.7 inches. In another embodiment, the width W₃ is less than approximately 0.5 inches. In one embodiment, the width of the ribs 124′ and the width of the apertures 126′ may provide support for the crate 20 and may resist wearing and/or damage to the crate 20 during use, especially over extended periods of use.

In various embodiments, ribs described above may provide for handling of embodiments of crates without damage to crates, including, in one embodiment, over extended periods of handling of crates by machinery. In various embodiments, ribs described above may reduce deflection of the walls of the corner portions.

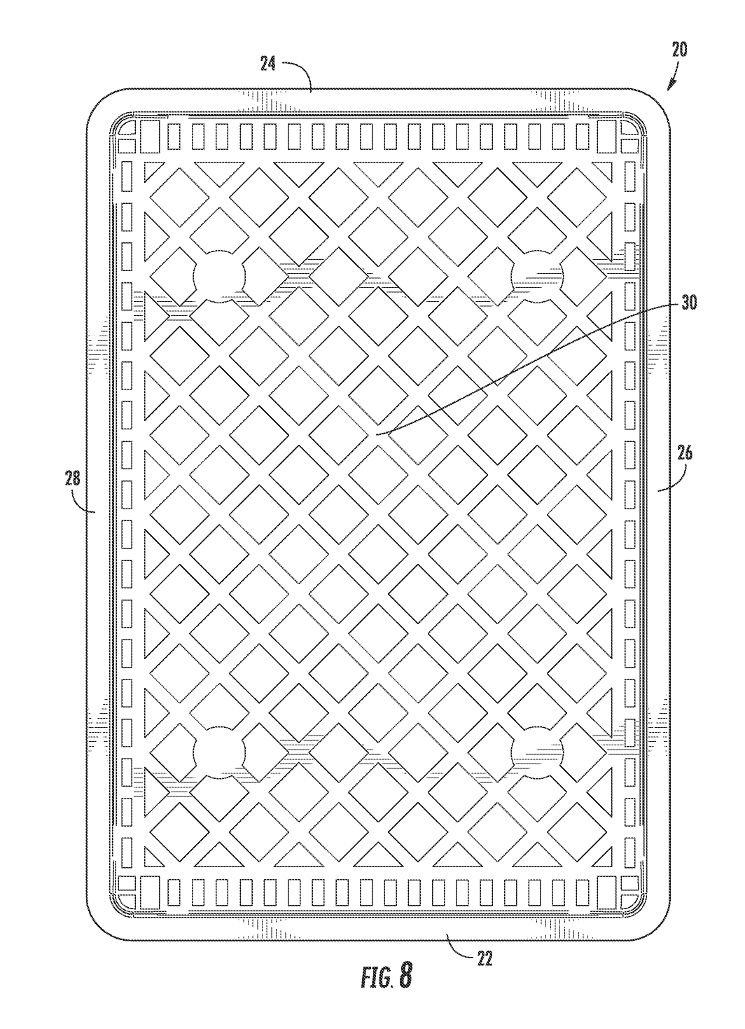

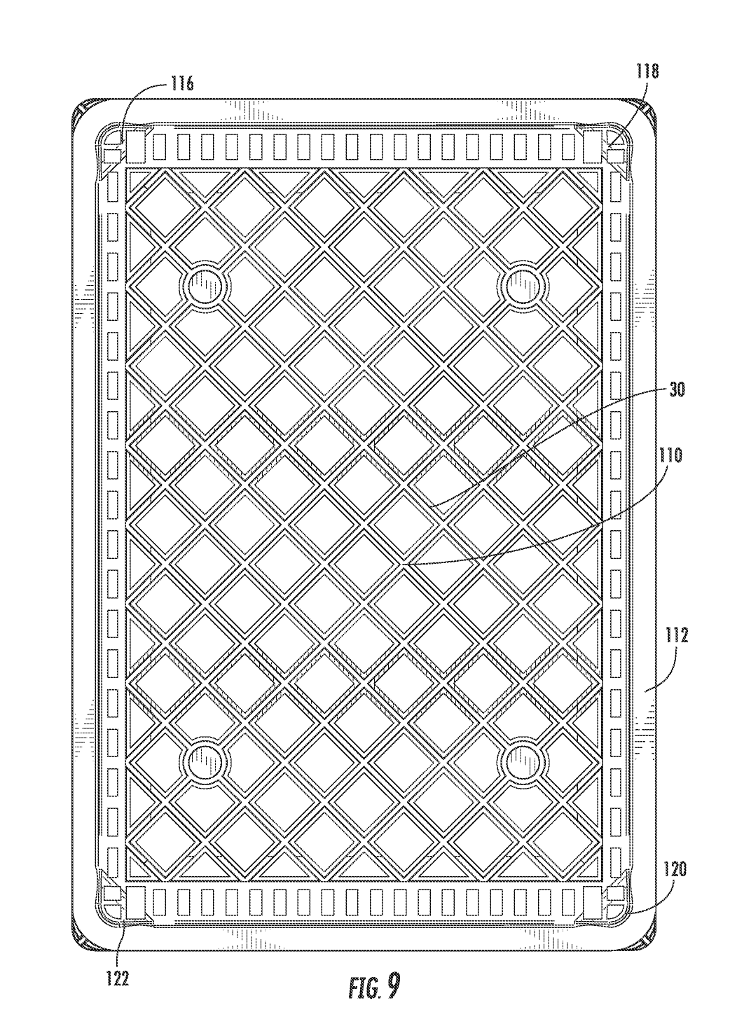

FIGS. 8 and 9 illustrate top and bottom plan views of an embodiment of a crate 20.

In one embodiment, crates are formed by molding. In one embodiment, crates are formed by injection molding. In one embodiment, crates are formed by two-part molding. In other embodiments, crates may be formed by any other suitable form of molding. In other embodiments, crates may be formed by any other suitable method and/or mechanism.

In one embodiment, crates are formed of plastic. In one embodiment, crates are formed of thermoplastic. In another embodiment, crates are formed of a thermosetting polymer. In one embodiment, crates are formed of a polyolefin. In another embodiment, crates are formed of polypropylene. In another embodiment, crates are formed of high-density polyethylene (HDPE). In other embodiments, crates may be formed of any suitable type of plastic or mixture thereof. In other embodiments, crates may be formed of any other suitable material.

In one embodiment, a crate 20 is configured to hold containers containing volumes of products. In one embodiment, a crate 20 has an interior volume configured to hold containers containing between approximately 5 quarts and approximately 50 quarts of material. In one embodiment, a crate is configured with an interior volume of between approximately 5 quarts and approximately 50 quarts. In another embodiment, a crate 20 is configured with an interior volume of between approximately 10 quarts and approximately 30 quarts. In one embodiment, a crate 20 is configured with an interior volume of approximately 16 quarts. In another embodiment, a crate 20 is configured to hold containers containing a total volume of material of at least approximately 16 quarts. In another embodiment, a crate 20 is configured with an interior volume of approximately 24 quarts. In another embodiment, a crate is configured to hold containers containing a total volume of material of at least approximately 24 quarts.

In one embodiment, a crate 20 is configured to hold six containers each having a volume of approximately 1 gallon. In another embodiment, a crate 20 is configured to hold four containers each having a volume of approximately 1 gallon. In another embodiment, a crate 20 is configured to hold between two and eight containers each having a volume of approximately 1 gallon. In another embodiment, a crate 20 is configured to hold four, five, or six containers each having a volume of approximately 1 gallon.

With reference to FIG. 2, in one embodiment, the handle 36 has a height H₁. In one embodiment, the height H₁ is between approximately 1.5 inches and approximately 2.5 inches. In another embodiment, the height H₁ is between approximately 1.75 inches and approximately 2.25 inches. In another embodiment, the height H₁ is approximately 2.06 inches. In one embodiment, the aperture 44 is similarly dimensioned. In one embodiment, the height H₁ may provide for easy access by a user's hand through the aperture to grasp the solid upper portion 34.

In one embodiment, the handle 36 has a width W₁. In one embodiment, the width W₁ is between approximately 4 inches and approximately 5 inches. In another embodiment, the width W₁ is between approximately 4.25 inches and approximately 4.75 inches. In one embodiment, the width W₁ is less than approximately 4.5 inches. In one embodiment, the width W₁ is approximately 4.46 inches. In one embodiment, the aperture 44 is similarly dimensioned. In one embodiment, the width W₁ may provide for easy access by a user's hand through the aperture to grasp the solid upper portion 34.

In one embodiment, the open lattice or fence-patterned portions 38 and 46 include apertures that are regularly arranged and patterned and are generally diamond-shaped. In another embodiment, the apertures in open lattice or fence-patterned portions are round. In another embodiment, the apertures in open lattice or fence-patterned portions are triangular. In other embodiments, the apertures in open lattice or fence-patterned portions have any other polygonal or non-polygonal shape. In other embodiments, the apertures in open lattice or fence-patterned portions may be any suitable shape. In other embodiments, the apertures may be regularly or irregularly spaced or patterned throughout the open lattice or fence-patterned portions.

In one embodiment, the lower portion 110 base portion 30 is also configured with an open lattice configuration. In one embodiment, the lower portion 110 includes a plurality of apertures therethrough. In one embodiment, the apertures are generally diamond-shaped and spaced and patterned generally regularly in the lower portion 110. In another embodiment, the apertures are round. In other embodiments, the apertures may be any suitable shape and may be patterned in any suitable regular or irregular pattern in the lower portion 110.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A plastic crate comprising:
first, second, third, and fourth plastic walls each including an open-lattice portion, the first wall extending from the second wall generally perpendicularly, the third wall extending from the second wall distal from the first wall, the fourth wall extending between the first wall and the third wall distal from the second wall, the first and fourth walls including a corner portion; and
a base portion extending between the first, second, third, and fourth walls, the first, second, third, and fourth walls and the base portion forming an open-topped cavity having an interior cavity, the base portion including a central portion with a bottom surface extending in a first plane and a corner portion with a bottom surface extending from the central portion in a second plane, the second plane forming a non-zero angle with the first plane;
wherein the corner portion includes a post portion and a projecting wall extending outwardly from the post portion, the projecting wall defining a first channel and a second channel spaced apart from the first channel.

2. The crate of claim 1, further comprising a rib extending from the post portion to the projecting wall.

3. The crate of claim 1, the projecting wall including a first side and a second side opposite the first side, the crate further comprising three pairs of ribs, the first ribs of each pair of ribs extending from the post portion to the first side of the projecting wall and the second ribs of each pair of ribs extending from the post portion to the second side of the projecting wall.

4. The crate of claim 1, wherein the wall has an outer surface distal from the post portion, the outer surface including a first portion extending generally vertically and a second portion extending generally downwardly from the first section at a non-zero angle.

5. The crate of claim 4, wherein the first wall includes a lower solid portion;
wherein the fourth wall includes a lower solid portion;
wherein the corner portion includes at least one rib extending from the lower solid portion of the first wall to the projecting wall proximate the first portion, and at least another rib vertically aligned with the at least one rib extending from the projecting wall to the lower solid portion; and
wherein the corner portion includes at least one rib extending from the lower solid portion of the first wall to the projecting wall proximate the second portion, and at least another rib vertically aligned with the at least one rib extending from the projecting wall to the lower solid portion.

6. The crate of claim 1, wherein the base portion further includes a raised portion surrounding the central portion, the raised portion being located in a first plane, the central portion being located in a second plane, the first and second planes being parallel and non-coplanar;
wherein the base portion includes a generally vertical wall portion extending between the central portion and the raised portion;
wherein the corner portion of the base portion and the generally vertical wall portion form an angle of greater than 90°.

7. The crate of claim 1, wherein the base portion includes more than 12 ribs spaced apart along a side of the central portion of the base portion proximate the first wall.

8. A plastic molded crate, comprising:
four plastic sidewalls and a plastic base portion forming an open-topped enclosure; and
four corner projecting walls each projecting angularly outwardly from a junction of two of the four sidewalls, each projecting wall including an outer surface defining an upper channel and a lower channel;
wherein the base portion includes a central portion having a lower surface located in a first plane and four corner portions, each corner portion having a lower surface located in a different plane forming a non-zero angle with the first plane.

9. The plastic molded crate of claim 8, further comprising more than three ribs extending between each wall and each corner projecting wall.

10. The plastic molded crate of claim 8, wherein the first sidewall and third sidewall have a shorter length than the second sidewall and the fourth sidewall; and
wherein the sides of the base portion proximate the first and third sidewalls each include more than twelve ribs.

11. The plastic molded crate of claim 10, wherein the sides of the base portion proximate the first and third sidewalls each include nineteen ribs.

12. The plastic molded crate of claim 8, wherein the outer surface of each of the four corner projecting walls includes a first portion below the lower channel extending parallel with the four sidewalls and a second portion forming a non-zero angle with the first portion.

13. The plastic molded crate of claim 12, wherein each of the four corner projecting walls extends a first horizontal distance proximate the first portion;
wherein each of the four corner projecting walls extends a second horizontal distance proximate the second portion; and
wherein the second horizontal distance is less than the first horizontal distance.

14. The plastic molded crate of claim 12, wherein the base portion further comprises a raised portion extending around the central portion and the corner portions of the base and a vertical wall portion extending between the raised portion and the central portion and the corner portions;
wherein the vertical wall portion forms an approximately 90° angle with each of the raised portion and the central portion; and
wherein the corner portions form an angle of greater than 90° with the vertical wall portion.

15. The plastic molded crate of claim 12, wherein the non-zero angles between the planes in which the lower surfaces of the corner portions are located and the first plane are greater than 10°.

16. The plastic molded crate of claim 12, wherein each sidewall defines an aperture configured to receive a hand of a user, each aperture having a height of at least 2 inches.

17. A method of providing a plastic crate comprising:
two-part molding a plastic crate having four walls, four corners, and a base portion, a bottom portion of each of the four corners being tapered inwardly, the base portion having a central portion with a lower surface located in a horizontal plane and four corners, each of the corners being angled upwardly relative to the horizontal plane, each of the four walls defining an aperture, the four walls and base portion forming an open-topped cavity with a volume of at least 16 quarts; and
shipping the plastic crate to a second location for filling.

18. The method of claim 17, wherein the plastic crate is molded from one of HDPE and polypropylene.

19. The method of claim 17, wherein the corners each include an upper channel and a lower channel, the method comprising locating a restraint in at least two of the channels.

20. The method of claim 17, wherein the length of two of the four walls is shorter than the length of the other two of the four walls; and
wherein a side of the base portion proximate one of the short walls includes more than twelve ribs.
